(19) United States
(12) Patent Application Publication
(10) Pub. No.: US 2002/0039084 A1
(43) Pub. Date: Apr. 4, 2002

(54) Medical image display system

(75) Inventor: Akira Yamaguchi, Kanagawa (JP)

Correspondence Address: SUGHRUE, MION, ZINN, MACPEAK & SEAS, 2100 Pennsylvania Avenue, N.W., Washington, DC, 20037, US

(73) Assignee: Fuji Photo Film Co., Ltd.

(21) Appl. No.: 09/965,890

(22) Filed: Oct. 1, 2001

(30) Foreign Application Priority Data
Sep. 29, 2000 (JP) 2000-299171

(51) Int. Cl. G09G 5/00

(52) U.S. Cl. 345/1.1

(57) ABSTRACT

The medical image display system has a plurality of flat panel displays, a casing for integrally accommodating the plurality of flat panel displays, a power source common to the plurality of flat panel displays, and a control unit for unifying and controlling the plurality of flat panel displays. The medical image display system can display a plurality of medical images with suitable sizes as soft copy images with a small space, and switching, exchange, image processing and the like of respective images can be easily performed.

### BACKGROUND OF THE INVENTION

1. Field of the Invention

The present invention relates to the field of a medical image display technique for displaying an image and the like taken by a medical diagnostic apparatus, and more specifically, to a medical image display system capable of arranging and displaying medical images as visual images on a plurality of displays.

2. Description of the Related Art

A medical image taken (measured) by a medical diagnostic apparatus such as an ultrasound diagnostic apparatus, a CT diagnostic apparatus, an MRI diagnostic apparatus, an X-ray diagnostic apparatus, or an FCR (Fuji computed radiography) is subjected to various image processing according to its necessity. Thereafter, the medical image is generally reproduced as a visual image on a film-shaped recording material by a printer such as a laser printer or a thermal printer, and then outputted as a hard copy.

In a medical care, a film, on which the medical image is reproduced, is observed using a light box called Schaukasten, and the medical image reproduced on the film is used for various diagnoses.

Also, in recent years, the medical image taken by the medical diagnostic apparatus is reproduced as a soft copy on a display device such as a CRT (cathode ray tube) to perform a diagnosis. Further, a diagnostic workstation equipped with a CRT is connected to a medical diagnostic apparatus via a network, and a diagnosis is performed in a consulting room etc., which is apart from the medical diagnostic apparatus, while observing the medical image that has been taken.

In order to perform a more accurate diagnosis in a medical care using the medical diagnostic apparatus, generally, a plurality of images are taken for each diagnosis and conditions or an angle therefor, and in addition a site whose image is to be taken are changed each time an image is taken. In a general diagnosis using a Schaukasten, a plurality of films, on which the thus taken medical images are reproduced, are arranged on the Schaukasten, and the diagnosis is performed while comparing and observing the respective images.

However, in the case where a medical image measured by the medical imaging (diagnostic) apparatus is displayed on a CRT to perform a diagnosis, it is common that one image is displayed on one CRT screen.

When a plurality of CRTs are arranged, a diagnosis with observing a plurality of medical images becomes possible as in the case where the Schaukasten is used. However, as is known, since the CRT has a large depth size and thus a large setting space according to the number of CRTs is required, it is generally difficult to employ such an arrangement. On the other hand, a plurality of medical images can be displayed on one CRT screen by image processing (electronic scaling processing). However, this causes a reduction in the image to be displayed, resulting in the difficulty to perform an accurate diagnosis, which is the most important factor.

### SUMMARY OF THE INVENTION

The present invention has been made to solve the above-mentioned problems inherent in the conventional technique, and therefore has an object to provide a medical image display system (electronic Schaukasten system), in which a large arrangement space is not required, a plurality of medical images with an appropriate size can be displayed as soft copies as in the case where a plurality of films are arranged on a Schaukasten, and in addition switching, exchange, image processing and the like of the respective images can be easily performed.

In order to attain the object described above, the present invention provides a medical image display system comprising: a plurality of flat panel displays; a casing for integrally accommodating the plurality of flat panel displays; a power source common to the plurality of flat panel displays; and a control unit for controlling the plurality of flat panel displays.

Preferably, at least one of the plurality of flat panel displays has a holding unit for holding a medical film to superpose it on an image displaying screen, and has a function for moving a pointer in a state that white color is displayed on an entire region of the image displaying screen of the at least one of the plurality of flat panel displays having the holding unit.

Preferably, the control unit has at least one function selected from the group consisting of a function for moving an image displayed on each of the plurality of flat panel displays, a function for scaling an image displayed on each of the plurality of flat panel displays, and a function for displaying a specified region with black color.

Preferably, the control unit comprises at least one of one or more control devices connected from an outside of the casing and a control device incorporated in the casing, the control device controlling one or more of the plurality of flat panel displays.

Preferably, the control unit has at least one control function selected from the group consisting of a control function with a remote controller, a control function with a voice input, a control function with an operational panel provided in the casing, and a control function using one or more of the plurality of flat panel displays as a touch panel.

Preferably, at least one of the plurality of flat panel displays has at least one selected from the group consisting of a screen size, a pixel size, the number of pixels, and an aspect ratio, which is different from the other of the plurality of flat panel displays.

Preferably, in each of the plurality of flat panel displays, a display screen size in a diagonal line direction is 10 inches to 25 inches, a pixel size is 50 μm to 240 μm, the number of pixels is 1600 pixels×1600 pixels or more, and an aspect ratio is 1 to 4/3.

Preferably, the casing has a light box for medical film observation.

Preferably, the plurality of flat panel displays include one or more flat panel displays for displaying a color image and one or more flat panel displays for displaying a monochrome image that are coexist in the casing, and the control unit judges whether an image to be displayed is a color image or a monochrome image to allow a corresponding flat panel display to display the image.

Preferably, the plurality of flat panel displays include one or more flat panel displays for displaying a color image, and one of the one or more flat panel displays for displaying the color image is used as an interface for controlling image displaying in each of the others of the plurality of flat panel displays.

Preferably, in accordance with designation of an image displayed on one of the plurality of flat panel displays, at least one of an image obtained by enlarging the displayed image and an image obtained by image-processing the displayed image is displayed on at least one of the others of the plurality of flat panel displays.

Preferably, in accordance with measurement results of luminance gradation characteristics of each of the plurality of flat panel displays, which is individually measured, maximum luminance values of all of the plurality of flat panel displays are set to a predetermined value equal to or smaller than a maximum luminance value of a flat panel display in which the maximum luminance value is lowest, and middle range of the luminance gradation characteristics of all of the plurality of flat panel displays are adjusted.

Preferably, the medical image display system further comprises an output unit for outputting a hard copy.

Preferably, the output unit of the hard copy is a dry printer.

Preferably, each of the plurality of flat panel displays is a liquid crystal display.

### BRIEF DESCRIPTION OF THE DRAWINGS

In the accompanying drawings:

FIG. 1 is a conceptional view of a basic structure of a medical image display system of the present invention;

FIG. 2 is a conceptional view showing one example of a method of controlling the medical image display system of the present invention;

FIG. 3 is a conceptional view of another example of the medical image display system of the present invention; and

FIGS. 4A to 4C are graphs for explaining a method of adjusting luminance gradation characteristics in the medical image display system of the present invention.

### DETAILED DESCRIPTION OF THE PREFERRED EMBODIMENTS

Hereinafter, a medical image display system of the present invention will be described in detail with reference to preferred embodiments of the invention described in the accompanying drawings.

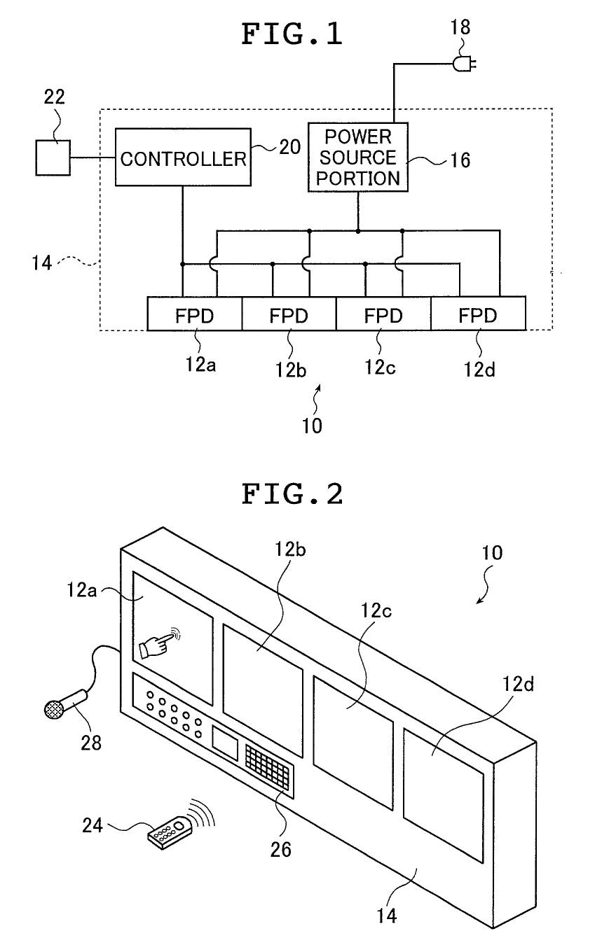

FIG. 1 shows a conceptional structure of one example of a medical image display system (electronic Schaukasten) of the present invention.

A medical image display system 10 shown in the drawing (hereinafter referred to as a display system 10) has four flat panel displays (hereinafter referred to as FPDs) 12, that is, FPD 12a, FPD 12b, FPD 12c, and FPD 12d as an example.

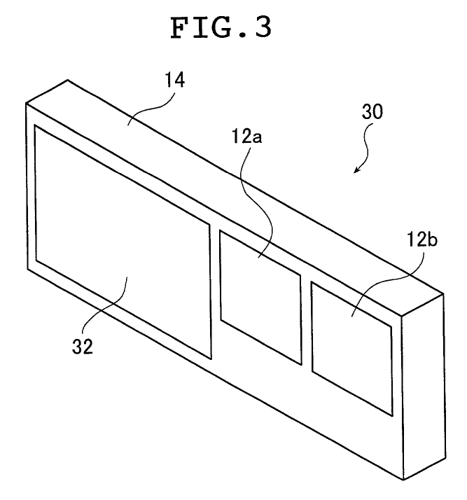

In the medical image display system 10 of the present invention, for example, as shown in FIG. 2 or 3, a plurality of FPDs 12 are accommodated and held in one casing 14 as an integral structure as a whole, whereupon image displaying surfaces are made to face toward the outside. Also, a drive power is supplied from a common power source portion 16 to all the FPDs 12. Note that reference numeral 18 in the drawing denotes a plug connected with a power source socket (receptacle) in a facility such as a hospital, where the display system 10 of the present invention is used.

Note that the FPD is a thin type image display device(?) with a plate shape, such as a liquid crystal display (LCD), a plasma display panel (PDP), an organic EL (electroluminescent) display, and an FED (field emission display). Among others, the LCD is preferably used.

In the display system 10 of the present invention, such FPDs 12 are used and, further, commonality of the power source is made and image display, for example, by all the FPDs 12 is controlled by one controller 20 as described later. Thus, a plurality of medical images (hereinafter simply referred to as images) can be simultaneously displayed in an extremely smaller space with simpler and more satisfactory operability, as compared with the case where the CRT is used.

In the display system 10 of the shown example, the image display and the like by the respective FPDs 12 can be controlled by one controller 20. In the example shown in figure, the controller 20 is also accommodated in (built into) the casing 14.

The controller 20 is constructed of a known workstation (WS), a known personal computer (PC) or the like having a CPU, a frame memory, a hard disk, and the like. The controller 20 as such is connected to a medical diagnostic apparatus such as an MRI diagnostic apparatus or an X-ray diagnostic apparatus; receives image data of the taken images, etc.; and performs image processing such as a density correction and a gradation correction, if necessary. Also, the controller 20 allows the respective FPDs 12 to display an image, an operational instruction through a GUI (graphical user interface) and the like in accordance with a control instruction as described later, or the like.

Also, it may employ such a configuration that frequently used images, reference images, etc. are stored in a hard disk so that the images may be arbitrarily read out therefrom for displaying on the FPDs 12.

The controller 20 is, preferably, freely connected to a network in a medical facility such as a hospital, where the display system 10 is used, through a connector 22.

Also, in the display system 10 of the present invention, the casing 14 may be transportable on casters or the like. Note that, when the controller 20 is not accommodated in the casing 14, casters may also be provided for the controller 20. Thus, the display system 10 of the present invention can be used at an arbitrary location in a facility such as a hospital, at which location a network cable is arranged, simply by moving the casing 14 to the location and connecting the connector 22 with the network cable.

In the display system 10, for example, a displayed image may be controlled by a known method using a keyboard, a mouse or the like, which is connected to the controller 20.

Preferable control methods include such methods as schematically shown in FIG. 2: one using a remote control 24 utilizing infrared rays or the like; one using an operational panel 26 located on the surface of the casing 14; one using at least one of the FPDs 12 (FPD 12a in the drawing) as a touch panel; and one using a voice input via a built-in microphone or a microphone 28 externally connected. Note that control may be realized by such methods performing known operations. Also, a plurality of operations including an operation with a keyboard or the like may be used in combination, or any of them may be selected.

Among others, an operation with a voice input is useful in the case of a diagnosis which is performed while viewing medical images displayed on the FPDs 12 under conditions not capable of manually controlling the system, such as a diagnosis using an endoscope. For example, a patient's name, the region whose image has been already taken, the designation of a medical diagnostic apparatus and the like are voice-inputted and a corresponding image is displayed on any of the FPDs 12 of the display system 10. Thus, a diagnosis is allowed while comparing such an image with a medical image of the region being examined at present.

Note that specific examples of such display control as described above include selection of the medical diagnostic apparatus from which an image is received (selection of modality), selection and control of the image to be displayed (the region whose image has been taken, a patient's name and the like) and the character information to be displayed as well, control of display positions of various symbols, selection of the FPDs 12 displaying images (for example, as to which medical images are to be displayed on which FPDs 12), exchange of images displayed on the respective FPDs 12, scaling of an image, trimming, movement of an image, image processing (density adjustment, gradation adjustment, sharpness enhancement or the like), and display luminance adjustment.

Also, when an image displayed on a given FPD 12 is specified, the controller 20 may cause at least one FPD 12 other than the above one to display an image obtained by enlarging the specified image or by subjecting the specified image to some kinds of image processing.

In the display system 10 of the shown example, the controller 20 is accommodated in the casing 14 and made integral with it. However, the present invention is not limited to such integration, and the controller 20 may be connected from the outside of the casing 14.

Alternatively, the display system 10 may include both a built-in controller 20 and a controller 20 externally connected. Also, a plurality of controllers 20, which are externally connected, may be provided. In the case where a plurality of controllers 20 are provided, it is sufficient if at least one of them can control display by all the FPDs 12 (four FPDs in the shown example). However, it is preferable that all the controllers 20 can control display by all the FPDs 12. In the case where a plurality of controllers 20 are provided, it is also preferable that the display system 10 is constructed such that the respective controllers 20 are used in a time shared manner.

For example, in the case where two controllers 20 are connected, a doctor “A” uses one of the controllers 20 to cause the FPDs 12 to display images and performs a diagnosis, during which another doctor “B” uses the other controller 20 to perform an operation which must be performed before image display, such as selection of images to be displayed. When the doctor “A” completes the diagnosis using images and feeds information indicating the completion of diagnosis into the system, images are newly displayed in accordance with what the doctor “B” has inputted in advance.

In the display system 10 of the present invention, as described above, various known display devices can be used as the FPDs 12. Among others, an LCD is preferably used.

According to the study of the inventors of the present invention, when the display screens of the FPDs 12 have a size and a shape, which are similar to those of a film observed using a Schaukasten (maximum size is 17 inches×17 inches and minimum size (metric is 6) is 24 cm×18 cm under present conditions), an observation and a diagnosis can be performed without feeling incongruity. When the number of pixels is small, the resolution is decreased and thus an accurate diagnosis cannot be performed. When the size of a pixel to be displayed is too large, extreme pixelization will occur, which is not preferable.

In view of the above points, it is preferable that the FPDs 12 used in the present invention have a screen size (along a diagonal) of 10 inches to 25 inches, an aspect ratio of 1 to 4/3, the number of pixels of UXGA (1600 pixels×1200 pixels) or more, and a pixel size of 240 μm or smaller.

Note that it is disadvantage in cost and the like if the pixel size is too small. In such a case, in addition, if the number of pixels is not increased, a sufficient image size might not be obtained. Thus, it is preferable that a pixel size is 50 μm or larger.

Also, it is not required that the FPDs 12 used in the display system 10 of the present invention are all identical. At least one of them may have at least one of the above four attributes, namely the screen size, the pixel size, the number of pixels and the aspect ratio, different from that of the others.

For example, in the case of an image taken by an X-ray diagnostic apparatus, an MRI diagnostic apparatus or the like, the FPD 12 having a screen size (diagonal) of about 20 inches and a pixel size of about 200 μm is preferred. On the other hand, in the case of mammography, the screen size of about 10 inches to 12 inches will suffice. In this case, however, since image taking is performed with a pixel size of about 50 μm, an image with a high resolution (for example, about 200 dpi corresponding to a pixel size of 127 μm) is required in order to perform an accurate diagnosis.

That is, according to the present invention, when a display system has at least one FPD 12, whose above-mentioned attributes are conditioned differently from those of the other FPDs 12, the display system can be suitably adapted to various medical diagnostic apparatuses.

In the display system 10 of the present invention, the FPDs 12 may be all color displays for displaying color images, all monochrome displays for displaying monochrome images, or a combination of color displays and monochrome displays.

Further, when the display system 10 has a color display as an FPD 12, both a color image and a monochrome image may be displayed thereon.

Preferably, at least one of the FPDs 12 is set to be a color display and used as an interface for operating the display system 10, and then various pieces of information for controlling image display are displayed thereon. In accordance with the information, the above various controls such as those of display position, image processing condition and the like regarding an image, character information, or a symbol, which are to be displayed on the other FPDs 12, are performed using the keyboard, the mouse, the remote control 24, the operational panel 26, the microphone 28, the touch panel or the like.

More preferably, a combination of color displays and monochrome displays is used and thus an image is displayed on an FPD 12 more suitable for it.

For example, in the case of an image obtained with an endoscope, a color Doppler image-taking with an ultrasound diagnostic apparatus, a three dimensional image obtained with a CT diagnostic apparatus, an angiograph taken with an MRI diagnostic apparatus or the like, it is difficult to perform a diagnosis using gray scale images. Thus, a diagnosis using color images is preferable. On the other hand, in the case of an image taken with an X-ray diagnostic apparatus or an FCR, a diagnosis using monochrome images displayed with a high gradation resolution and a high luminance is preferable.

Therefore, when color displays and monochrome displays are used in combination as the FPDs 12 and appropriately selected for display, suitable image display can be made corresponding to various medical diagnostic apparatuses. At this time, it is further preferable that the controller 20 determines whether the data on an image to be displayed is data on a color image or on a monochrome image and allows the FPD 12 adapted to the image in question to display.

In medical diagnostic apparatuses, for example, 10-bit digital image data is provided as image data by the FCR. On the other hand, the gradation resolution of an LCD suitably used as an FPD 12 in the present invention is generally 8 bits.

In many cases, a monochrome LCD has a structure obtained by removing color filters from a color LCD, and thus has three subpixels for one pixel. In the display system 10 of the present invention, it is preferable that the subpixels are actively used and individually modulated (generally, all are modulated with the same image data), and thus a monochrome image is displayed with a higher gradation resolution.

For example, in the case of 8-bit LCD, when the subpixels are used, a gradation corresponding to the gradation resolution of 9.5 bits (766 levels) can be represented. Therefore, a dropout of 10-bit image data supplied from a medical diagnostic apparatus is minimized and thus a high quality image can be displayed.

In the display system 10 of the present invention, IDs of patients and the like may be inputted in advance to display taken images in succession for each patient.

The number of images taken to display in various diagnoses may vary according to the occasion. For example, it generally varies from patient to patient: 4 for a first patient A, 2 for a next patient B, 3 for a further next patient C, and so on.

In accordance with this, when the number of images to be displayed is smaller than that of FPDs 12 in the display system 10 of the present invention, in order to improve visibility and prevent misidentification, it is preferable to clear the screens of the FPDs 12, on each of which no image is to be displayed (that is, excess FPDs 12), and allow nothing to be displayed on the FPDs 12 in question. In particular, it is preferable with the FPDs 12, on each of which no image is to be displayed, to effect black color display to lower the luminance or, in the case of LCDs or the like, to turn off back lights in order not to disturb the observation of images on the FPDs 12 under display.

According to the present invention, the display system may include not only the FPDs 12(12a and 12b) but also a light box (Schaukasten) 32 for observing a film on which an image taken by a medical diagnostic apparatus is reproduced, as in the case of a medical image display system 30 schematically shown in FIG. 3. Note that a Schaukasten similar to that generally used in a hospital or the like may be used as the light box 32.

Thus, the image which has already taken and reproduced on a film and the newly taken image can be arranged and compared with each other to perform a diagnosis.

It is also possible in the display system 10 of the present invention that, without employing the light box 32 in particular, a film holding device such as a clip is provided in at least one of the FPDs 12 for holding a film overlapping the screen of the FPD 12. The FPD 12 provided with the film holding device may function as a Schaukasten by displaying on its entire screen white color, preferably with the highest luminance.

As the film holding device, a known film holding device used in a Schaukasten or the like may be used. Further, the film holding device may have a sensor or the like. Once the fact that the film has been held is detected, the FPD 12 provided with such a film holding device will automatically be allowed to display white color, as corresponding to a Schaukasten.

When an FPD 12 is used as a Schaukasten, a pointer, which is movable with a mouse or the like, may be displayed on the FPD 12, and thus an arbitrary position on the held film may be pointed. In addition, in order to make unnecessary areas on the film invisible to obtain more satisfactory visibility in necessary areas, black color (low luminance) display may be effected in the areas on the screen of the FPD 12 that correspond to the above unnecessary areas by area definition using a mouse or the like.

In this embodiment, where the function as a Schaukasten is provided for the FPDs 12, an image may be displayed on the FPD 12 whose film holding device is holding a film. At this time, movement, scaling or the like of the displayed image are carried out by the control as described hereinbefore to allow the image on the film and the displayed image to overlap each other. Thus, the change in a condition of a patient and others can be grasped.

The display system 10 of the present invention may have a built-in printer for outputting an image displayed on an FPD 12 as a hard copy, or such a printer may be freely connected to the system 10 using the controller 20.

Note that various known printers can be used as the printer. Preferably, a so-called dry printer (dry type printer) such as a thermal printer is indicated as an example. The hard copy outputted from a printer may be of a film shape (transmission image) or a paper shape (reflection image). Moreover, an image to be recorded may be a high quality image adaptable to a diagnosis or a simple image for making a rough check.

In the display system 10 of the present invention having a plurality of FPDs 12, it is preferable that all the FPDs 12 have a uniform luminance gradation characteristic.

Thus, it is preferable that the display system 10 of the present invention has a function for adjusting the luminance gradation characteristics of the respective FPDs 12 in such a manner as described below.

First, the luminance gradation characteristics of the respective FPDs 12 are measured by using a luminance measurement apparatus.

The method of measuring the luminance gradation characteristics is not limited to a specific method. As an example, there is a method wherein the FPDs 12 are initially set such that their light quantities (luminance values) be maximum and thus their maximum luminance values are measured. Then, the luminance of the FPDs 12 are caused to vary by changing image data in succession and measured for each image data.

Next, the FPD 12 having the maximum luminance value which is the lowest is selected, the target maximum luminance value is set to be equal to or lower than the maximum luminance value of this FPD 12, and the maximum luminance values of all the FPDs 12 are adjusted to the target maximum luminance value. The method of adjusting the maximum luminance values of the respective FPDs 12 can be suitably selected in accordance with the kind of FPD. For example, in the case of an LCD, the light intensity of a back light may be controlled.

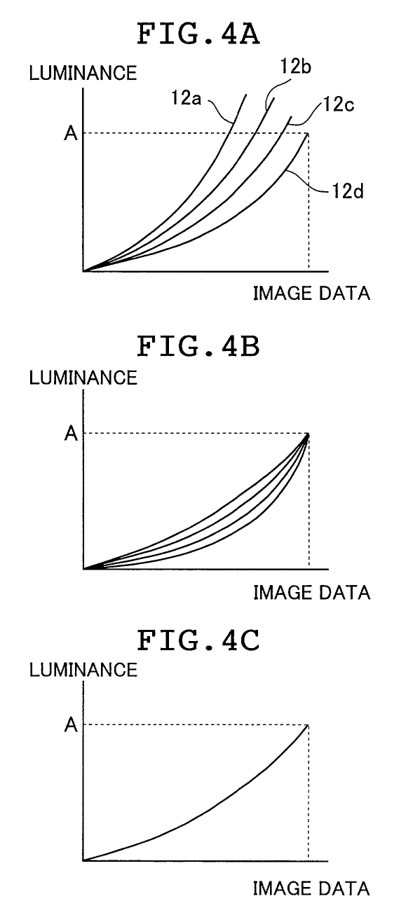

If luminance gradation characteristics (image data vs. display luminance) as shown in FIG. 4A are obtained in the respective FPDs 12 by the above measurement, the maximum luminance value of the FPD 12d (luminance value “A”) is the lowest. Thus, the target maximum luminance value may be set to be equal to or lower than the luminance value “A”. In the shown example, the value “A” is employed as the target maximum luminance value.

Generally, when the maximum luminance value of an FPD 12 is adjusted, the luminance gradation characteristic changes in accordance with the change in the maximum luminance value while keeping the similarity of characteristic curves. Thus, by the maximum luminance value adjustment, the luminance gradation characteristics of the respective FPDs 12 are as shown in FIG. 4B, for example.

Next, in order to obtain a uniform luminance gradation characteristic regarding all the FPDs 12, as shown in FIG. 4C, LUTs (look up tables) for correcting the provided image data are prepared for the respective FPDs 12 and set in them respectively (or, the LUTs already set in the respective FPDs 12 are updated). In consequence, images can be displayed on the FPDs 12, which all have a uniform luminance gradation characteristic, and thus a more accurate diagnosis is allowed.

Note that the luminance gradation characteristic as the target may be a given one set in advance. Alternatively, any one of the FPDs 12 may be selected to employ its luminance gradation characteristic as the target. Further, as the method of preparing LUTs, a known method, which is performed in the so-called luminance calibration of a display, may be used.

Such adjustment of the luminance gradation characteristics of the respective FPDs 12 as above may be made by the controller 20. Alternatively, a unit for performing the adjustment may be separately provided.

The luminance measurement apparatus may be built into the display system 10.

The medical image display system of the present invention has been described in detail. However, the present invention is not limited to the above embodiments, and various improvements and modifications may be naturally made in the scope not departing from the gist of the present invention.

For example, in the above example, the display system has four FPDs 12. However, the present invention is not limited to this and the display system may include two or three FPDs 12, or alternatively, even five or more FPDs 12.

As described in detail, according to the medical image display system of the present invention, a large set space is not required, a plurality of medical images with suitable sizes can be displayed as soft copies as in the case where a plurality of films are arranged on a Schaukasten, and switching, exchange, image processing and the like of the respective images can be easily performed.

What is claimed is:

1. A medical image display system comprising:
a plurality of flat panel displays;
a casing for integrally accommodating said plurality of flat panel displays;
a power source common to said plurality of flat panel displays; and
a control unit for controlling said plurality of flat panel displays.

2. The medical image display system according to claim 1, wherein at least one of said plurality of flat panel displays has a holding unit for holding a medical film to superpose it on an image displaying screen, and has a function for moving a pointer in a state that white color is displayed on an entire region of the image displaying screen of said at least one of the plurality of flat panel displays having the holding unit.

3. The medical image display system according to claim 1, wherein the control unit has at least one function selected from the group consisting of a function for moving an image displayed on each of said plurality of flat panel displays, a function for scaling an image displayed on each of said plurality of flat panel displays, and a function for displaying a specified region with black color.

4. The medical image display system according to claim 1, wherein said control unit comprises at least one of one or more control devices connected from an outside of the casing and a control device incorporated in the casing, said control device controlling one or more of said plurality of flat panel displays.

5. The medical image display system according to claim 1, wherein the control unit has at least one control function selected from the group consisting of a control function with a remote controller, a control function with a voice input, a control function with an operational panel provided in the casing, and a control function using one or more of said plurality of flat panel displays as a touch panel.

6. The medical image display system according to claim 1, wherein at least one of said plurality of flat panel displays has at least one selected from the group consisting of a screen size, a pixel size, the number of pixels, and an aspect ratio, which is different from the other of said plurality of flat panel displays.

7. The medical image display system according to claim 1, wherein in each of said plurality of flat panel displays, a display screen size in a diagonal line direction is 10 inches to 25 inches, a pixel size is 50 μm to 240 μm, the number of pixels is 1600 pixels×1600 pixels or more, and an aspect ratio is 1 to 4/3.

8. The medical image display system according to claim 1, wherein said casing has a light box for medical film observation.

9. The medical image display system according to claim 1, wherein said plurality of flat panel displays include one or more flat panel displays for displaying a color image and one or more flat panel displays for displaying a monochrome image that are coexist in the casing, and said control unit judges whether an image to be displayed is a color image or a monochrome image to allow a corresponding flat panel display to display the image.

10. The medical image display system according to claim 1, wherein said plurality of flat panel displays include one or more flat panel displays for displaying a color image, and one of said one or more flat panel displays for displaying the color image is used as an interface for controlling image displaying in each of the others of said plurality of flat panel displays.

11. The medical image display system according to claim 1, wherein in accordance with designation of an image displayed on one of said plurality of flat panel displays, at least one of an image obtained by enlarging the displayed image and an image obtained by image-processing the displayed image is displayed on at least one of the others of said plurality of flat panel displays.

12. The medical image display system according to claim 1, wherein in accordance with measurement results of luminance gradation characteristics of each of said plurality of flat panel displays, which is individually measured, maximum luminance values of all of said plurality of flat panel displays are set to a predetermined value equal to or smaller than a maximum luminance value of a flat panel display in which the maximum luminance value is lowest, and middle range of the luminance gradation characteristics of all of said plurality of flat panel displays are adjusted.

13. The medical image display system according to claim 1, further comprising an output unit for outputting a hard copy.

14. The medical image display system according to claim 13, wherein said output unit of the hard copy is a dry printer.

15. The medical image display system according to claim 1, wherein each of said plurality of flat panel displays is a liquid crystal display.
